(19) United States
(12) Patent Application Publication
(10) Pub. No.: US 2026/0018583 A1
(43) Pub. Date: Jan. 15, 2026

(54) APPARATUS AND METHOD FOR MANUFACTURING DRY ELECTRODE

(71) Applicants: Hyundai Motor Company, Seoul (KR); Kia Corporation, Seoul (KR)

(72) Inventor: Hyun Jin Kim, Hwaseong (KR)

(21) Appl. No.: 18/945,290

(22) Filed: Nov. 12, 2024

(30) Foreign Application Priority Data
Jul. 11, 2024 (KR) 10-2024-0091469

(51) Int. Cl. H01M 4/04; B01F 23/57; B01F 27/90; B01F 35/45; B01F 35/71

(52) U.S. Cl. CPC H01M 4/04; B01F 23/57; B01F 27/90; B01F 35/45; B01F 35/718; H01M 4/0435

(57) ABSTRACT

A method for manufacturing a dry electrode for a secondary battery is described, involving the use of a mixer to combine materials without the use of solvents. The process begins by supplying a conductive material into the mixer, followed by the distribution of an electrode active material onto the conductive material. The mixer is then driven to ensure thorough mixing and complexing of the materials. A binder is introduced after the active material and conductive material have been combined, and the mixer is driven again to fiberize the binder. The resulting dry electrode mixture is then formed into a film using a roll press. This method allows for efficient production of dry electrodes with improved energy density and reduced manufacturing time and cost, offering a solvent-free alternative to traditional wet processes.

### CROSS-REFERENCE TO RELATED APPLICATION

This application claims, under 35 U.S.C. § 119(a), the benefit of Korean Patent Application No. 10-2024-0091469, filed on Jul. 11, 2024, the entire contents of which are incorporated herein by reference.

### TECHNICAL FIELD

The present disclosure relates to manufacturing of a dry electrode for a secondary battery.

### BACKGROUND

Recently, rechargeable secondary batteries have been expanding its application in various fields from a small electronic device to a large energy storage system. Particularly, with the rapid growth of the electric vehicle market, research and development on the secondary battery are being actively conducted.

The electrodes of the secondary battery have generally been manufactured through a wet process. In the wet process, electrode active material, binder, and conductive material included in the electrode are dissolved in a solvent to prepare a slurry. However, in recent years, a dry process performed without using a solvent which is needed in the wet process and capable of increasing the energy density of a battery compared to the wet process is receiving great attention.

In the dry process of manufacturing an electrode, an electrode active material, a conductive material, and a binder are mixed without a solvent to form a mixture, and then the mixture is formed into a dry electrode film using a press or calendering method. The dry electrode film is then attached to a current collector, completing the manufacture of the electrode.

Compared to the wet process, the dry process does not use a solvent, thereby reducing manufacturing time and cost, and the thickness of film may be controlled in the dry process, obtaining a dry electrode film having a high energy density.

In manufacturing a free-standing dry electrode, complexing electrode active material and conductive material and fiberizing binder, which are performed during the mixing process, are important. Accordingly, research on effective complexing and fiberizing methods is being actively conducted.

The information disclosed in this Background section is provided solely to enhance the understanding of the background of the present disclosure. Therefore, it may contain information that does not form the prior art that is already known to a person of ordinary skill in the art.

### SUMMARY OF THE DISCLOSURE

The present disclosure has been made in an effort to solve the above-described problems associated with the prior art, and an object of the present disclosure is to provide an apparatus and method for manufacturing a dry electrode, capable of effectively complexing electrode active material and conductive material.

Another object of the present disclosure is to provide an apparatus and method for manufacturing a dry electrode, capable of manufacturing a high-quality dry electrode.

The object of the present disclosure is not limited to the foregoing, and other objects not mentioned herein will be clearly understood by one having ordinary skill in the art to which the present disclosure pertains based on the description below.

The features of the present disclosure to achieve the object of the present disclosure as described above and to perform the characteristic functions of the present disclosure to be described later are as follows.

According to some embodiments of the present disclosure, a method for manufacturing a dry electrode includes supplying a conductive material into a mixer, distributing an electrode active material on the conductive material within the mixer, and driving the mixer. The method may involve distributing the electrode active material onto the conductive material within the mixer at a height that results in little to no potential energy difference between the two materials. The method may involve forming a buffer layer on the conductive material by positioning the electrode active material close enough to the conductive material to prevent floating before distribution. Once the electrode active material is placed on the buffer layer, the buffer may be removed, allowing the active material to fall onto the conductive material. The process may further involve supplying a binder into the mixer after the active and conductive materials have been mixed. The resulting mixture of the electrode active material, the conductive material, and the binder may be directed to a roll press, where it is formed into a film. The method may result in the manufacture of a dry electrode, which may be used in a secondary battery.

According to some embodiments of the present disclosure, an apparatus for manufacturing a dry electrode includes a vacuum conveyor configured to deliver a material including an electrode active material, a conductive material, and a binder, a mixer supplied with the material delivered by the vacuum conveyor and configured to mix the material, and a separator capable of being introduced into the mixer. The apparatus may include a mixer with a chamber that is rotatable and equipped with a rotatable blade. It may also include an actuator designed to move the separator into or out of the mixer. The mixer could have an opening through which the separator passes, and it may also feature a door that can open and close in sync with the insertion or removal of the separator. The separator may contain an area where the electrode active material is arranged within the mixer. A controller could be included to manage the operation of the vacuum conveyor, mixer, and separator. The controller may be configured to supply the conductive material into the mixer via the vacuum conveyor, introduce the separator, distribute the electrode active material onto the separator, and then remove the separator from the mixer. After the separator is removed, the controller may operate the mixer and, following this, supply a binder into the mixer via the vacuum conveyor to drive the mixing process. A dry electrode may be manufactured using this apparatus, which may be incorporated into a secondary battery.

In some embodiments, a method for manufacturing a dry electrode is provided. The method includes supplying a conductive material into a mixer; forming a buffer layer between an electrode active material and the conductive material; distributing the electrode active material onto the conductive material within the mixer by removing the buffer layer; driving the mixer to mix the conductive material and the electrode active material; introducing a binder into the mixer after the electrode active material and conductive material have been complexed; and driving the mixer to fiberize the binder, thereby forming a dry electrode mixture.

Other aspects and preferred embodiments of the present disclosure are discussed infra.

As discussed, the method and system suitably include use of a controller or processer.

The above and other features of the present disclosure are discussed infra.

### BRIEF DESCRIPTION OF THE DRAWINGS

The above and other features of the present disclosure will now be described in detail with reference to certain embodiments thereof illustrated in the accompanying drawings which are given herein below by way of illustration only, and thus are not limitative of the present disclosure, and wherein:

FIG. 1 is a schematic view of an apparatus for manufacturing a dry electrode according to an embodiment of the present disclosure;

FIG. 2 illustrates a mixer of an apparatus for manufacturing a dry electrode according to some embodiments of the present disclosure;

FIGS. 3A and 3B are schematic views illustrating a mixing state of an electrode active material and a conductive material, wherein the conductive material is put into a mixer after the electrode active material is put into the mixer;

FIGS. 4A and 4B are schematic views illustrating a mixing state of a conductive material and an electrode active material, wherein the electrode active material is put into a mixer after the conductive material is put into the mixer;

FIGS. 5A and 5B are schematic views illustrating a mixing state of an electrode active material and a conductive material, wherein a buffer layer is formed in a mixer and the electrode active material and conductive material are mixed together according to an embodiment of the present disclosure;

FIG. 6 is a schematic view of a mixer of an apparatus for manufacturing a dry electrode according to an embodiment of the present disclosure;

FIGS. 7A and 7B are schematic views illustrating the states before and after the operation of a separator for a mixer of an apparatus for manufacturing a dry electrode according to an embodiment of the present disclosure;

FIGS. 8A and 8B each illustrate an actuator of a separator for a mixer of an apparatus for manufacturing a dry electrode according to another embodiment of the present disclosure;

FIGS. 9A, 9B, and 9C each illustrate a separator for a mixer of an apparatus for manufacturing a dry electrode according to another embodiment of the present disclosure;

FIGS. 10A and 10B illustrate the inside of a mixer of an apparatus for manufacturing a dry electrode according to an embodiment of the present disclosure, viewed from V1 in FIG. 6;

FIGS. 11A, 11B, and 11C illustrate the operation of a door provided in a mixer of an apparatus for manufacturing a dry electrode according to an embodiment of the present disclosure;

FIG. 12 illustrates the operation of a mixer of an apparatus for manufacturing a dry electrode according to an embodiment of the present disclosure, wherein the mixer is operated while being arranged parallel to a horizontal plane;

FIG. 13 illustrates the operation of a mixer of an apparatus for manufacturing a dry electrode according to an embodiment of the present disclosure, wherein the mixer is operated while being arranged at an angle to a horizontal plane;

FIG. 14 shows average electrical conductivities of the samples in Table 1;

FIG. 15A is an electron microscope image of Comparative Embodiment 2 or 3 in Table 1; and

FIG. 15B is an electron microscope image of Embodiment 1 or 2 in Table 1.

It should be understood that the appended drawings are not necessarily to scale, presenting a somewhat simplified representation of various preferred features illustrative of the basic principles of the present disclosure. The specific design features of the present disclosure, including, for example, specific dimensions, orientations, locations, and shapes, will be determined in part by the particular intended application and usage environment.

In the figures, the reference numbers refer to the same or equivalent parts of the present disclosure throughout the several figures of the drawing.

### DETAILED DESCRIPTION

As discussed above, the present disclosure relates to manufacturing of a dry electrode for a secondary battery. In certain aspects, the disclosure provides methods and apparatuses for forming dry electrodes by combining conductive materials, electrode active materials, and binders within a mixer. In certain aspects, the disclosed methods utilize a buffer layer to prevent floating of materials during mixing, and a separator system to ensure uniform distribution of the electrode active material onto the conductive material. Additionally, the present disclosure describes processes for fiberizing binders and forming the dry electrode mixture into a film through a roll press. The dry electrodes produced by these methods can be particularly suitable for use in secondary batteries, where they enhance energy density, electrical conductivity, and overall performance.

Descriptions of specific structures or functions presented in the embodiments of the present disclosure are merely exemplary for the purpose of explaining the embodiments according to the concept of the present disclosure, and the embodiments according to the concept of the present disclosure may be implemented in various forms. In addition, the descriptions should not be construed as being limited to the embodiments described herein, and should be understood to include all modifications, equivalents and substitutes falling within the idea and scope of the present disclosure.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMS, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Meanwhile, in the present disclosure, terms such as “first” and/or “second” may be used to describe various components, but the components are not limited by the terms. These terms are only used to distinguish one component from another. For example, a first component could be termed a second component, and similarly, a second component could be termed a first component, without departing from the scope of embodiments of the present disclosure.

It will be understood that, when a component is referred to as being “connected to” or “brought into contact with” another component, the component may be directly connected to or brought into contact with the other component, or intervening components may also be present. In contrast, when a component is referred to as being “directly connected to” or “brought into direct contact with” another component, there is no intervening component present. Other terms used to describe relationships between components should be interpreted in a like fashion (e.g., “between” versus “directly between,” “adjacent” versus “directly adjacent,” etc.).

Hereinafter, the present disclosure is described in detail with reference to the accompanying drawings.

A dry electrode may be prepared from a dry electrode mixture and a current collector, without a solvent. A dry electrode mixture M comprises an electrode active material, a conductive material (conductive additive or conducting agent), and a binder. Moreover, the dry electrode mixture M may further comprise an additive.

The dry electrode may be a cathode or an anode. In some embodiments, when the cathode is prepared, the electrode active material includes a cathode active material. As a non-limiting example, the cathode active material may be LCO(LiCoO2), NCM(Li(Ni,Co,Mn)O2), NCA(Li(Ni,Co,Al)O2, LMO(LiMnO4), LFP(LiFePO4), or sulphur.

In some embodiments, when the anode is prepared, the electrode active material includes an anode active material. For example, the anode active material may be natural graphite, artificial graphite, mesocarbon microbeads (MCMB), or silicon series.

The conductive material may be a carbon-based material. For example, the conductive material may be carbon black, acetylene black, carbon fiber, or carbon nanotube.

The binder may be polyvinylidene fluoride (PVDF), polytetrafluoroethylene (PTFE), or a copolymer comprising the same.

As the additive, a solid polymer electrolyte, such as a polyethylene oxide (PEO), or an oxide-based or sulfide-based solid electrolyte component may be partially used.

The dry electrode mixture may contain 70 to 99.9% by weight of electrode active material, 0.1 to 20% by weight of conductive material, and 0.1 to 20% by weight of binder. Here, 0 to 20% by weight of additive may be added.

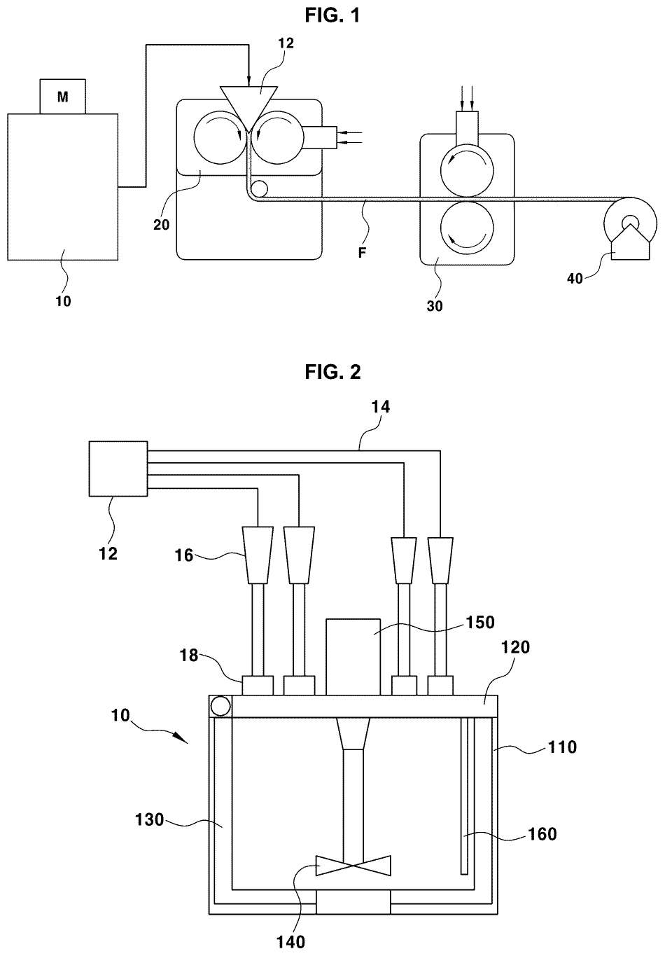

As illustrated in FIG. 1, the dry electrode mixture M is formed into a dry electrode film F through a series of film forming processes in which heat and pressure are applied. First, the dry electrode mixture M comprising electrode active material, conductive material, and binder is mixed by a mixer 10 for and at a predetermined time and speed. As a non-limiting example, the dry electrode mixture may be prepared by a high shear mixer using rotation or by a fluid mixer using air. The predetermined time and speed may be adjusted by changing the rotation speed and operation time of the mixer 10.

The dry electrode mixture M mixed in the mixer 10 may be formed into a film by a film forming apparatus. Specifically, the dry electrode mixture M mixed in the mixer 10 may be directed to a feeder 12 or to a roll press 20. The dry electrode mixture M may first be pressed into a film in an upstream roll press 20. The upstream roll press 20 rotates while providing a pressing force to form the dry electrode mixture M into a film. The dry electrode mixture M first formed into a film may further be pressed in a downstream roll press 30, and the thickness of the dry electrode mixture M may be adjusted through pressing. The dry electrode film F, which is the dry electrode mixture formed into a film, is then wound by a winder 40. Thereafter, the dry electrode film F is attached or laminated to a current collector to manufacture a dry electrode.

The dry electrode mixture M is powder in a state in which the electrode active material, conductive material, and binder are properly mixed and dispersed by the mixer 10 so as to be formed to be a film when pressed by a film forming apparatus, i.e., the roll press 20. The dry electrode mixture M may be said to be properly mixed and dispersed through fiberization of binder and complexation of conductive material.

In other words, in manufacturing a dry electrode in a form of a free-standing film, not only fiberizing binder but also complexing electrode active material and conductive material plays an important role. Complexing electrode active material and conductive material may be explained as the conductive material being coated on the surface of the electrode active material. The conductive material may be coated on the electrode active material by a strong shear force applied from the mixer 10. Fiberizing binder may be explained as the binder being stretched thin and long due to the strong shear force of the mixer 10 to connect the complexed electrode active material and conductive material as a network. Particularly, the fiberized binder may serve as a structure to form the dry electrode into a free-standing film.

Complexation of electrode active material and conductive material allows the conductive material to be uniformly dispersed and coated on the surface of the electrode active material to thereby form an electron transfer channel between the electrode active material to improve electron mobility. Moreover, the complexation may also affect the characteristics of collision energy between particles when binder is fiberized.

In the process of manufacturing a dry electrode, fiberizing binder and complexing electrode active material and conductive material may be performed in a mixing process using the mixer 10. In other words, by mixing electrode active material and conductive material, the conductive material is complexed to the electrode active material, and by fiberizing the binder by adding the binder to the complexed particles, a network may be formed in the dry electrode mixture.

The present disclosure is to propose a dry electrode manufacturing technology including a mixer, capable of effectively achieving inter-particle complexation of electrode active material and conductive material.

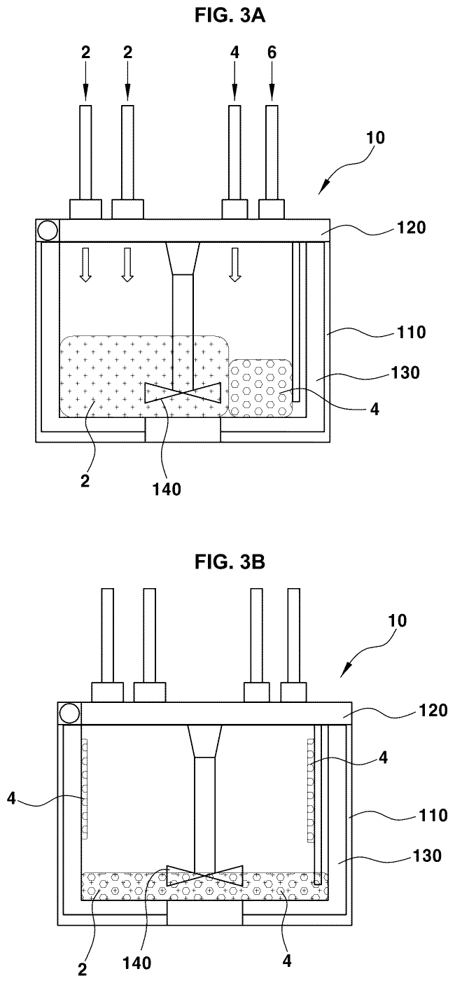

As illustrated in FIG. 2, according to an embodiment of the present disclosure, the mixer 10 may be supplied with materials included in the dry electrode mixture. As described above, the materials in the dry electrode mixture include an electrode active material, a conductive material, and a binder. The weight of each of the electrode active material, conductive material, and binder supplied to the mixer 10 may be measured up to a predetermined value using a measuring system 12. For example, the material may be supplied to a load cell through a circle feeder, a screw feeder, etc., and when the weight of the material measured by the load cell reaches a predetermined value, supply of the material through the feeder may be stopped.

The electrode active material, the conductive material, and the binder whose weights are measured may be supplied to the mixer 10 through a pipe 14. The materials in the dry electrode mixture may each be supplied to the mixer 10 through a corresponding pipe. In an embodiment, the electrode active material, the conductive material, and the binder may be vacuum conveyed through the pipe 14 and supplied to the mixer 10. As a non-limiting example, vacuum conveying may be performed by a vacuum conveyor 16.

The vacuum conveyor 16 may include one or more controllable valves 18. The electrode active material, the conductive material, or the binder delivered to the mixer 10 by opening and closing the valves 18 may be supplied into the mixer 10. Each valve 18 may be opened simultaneously or at different times. In an embodiment, each valve 18 may be opened in a predetermined order. According to an embodiment of the present disclosure, an electrode active material 2 and a conductive material 4 may be supplied to the mixer 10 to be mixed therein before a binder 6 is supplied to the mixer 10. This is because when the electrode active material, the conductive material, and the binder are mixed all at once, all the conductive material sticks to the binder, whereby the conductive material is not coated on the surface of the electrode active material and fiberization is not properly done.

The mixer 10 may include a housing 110 and a cover 120. The cover 120 may be detachably coupled to the housing 110. To supply each material transferred through the pipe 14 into the mixer 10, the cover 120 may connect the pipe 14 or valve 18 to the inside of the mixer 10.

In an embodiment, a space defined by the housing 110 and the cover 120 may be a chamber 130. Each material of the dry electrode mixture may be supplied into the chamber 130 and mixed in the chamber 130. The chamber 130 may be rotatable with respect to the housing 110 and the cover 120. In other words, the chamber 130 concentrically accommodated in the housing 110 may rotate with respect to the housing 110. In an embodiment, the chamber 130 may be provided with a cooling jacket through which refrigerant may flow.

The mixer 10 includes a rotatable blade 140. As the blade 140 rotates, a required energy is applied to the materials in the mixer 10, and the applied energy may complex the particles of the materials and fiberize the binder. In an embodiment, when the chamber 130 rotates, the blade 140 may rotate together therewith to mix the materials within the mixer 10. In other words, the housing 110 and the blade 140 may rotate together to mix the constituent materials of the dry electrode mixture. In an embodiment, the blade 140 may be driven by a motor 150, and the motor 150 may be supplied with power.

According to an embodiment of the present disclosure, the mixer 10 may further include a scraper 160. The scraper 160 scrapes off the material attached to the inner surface of the housing 110 using a centrifugal force when the mixer 10 is driven and allows the scraped material to be participated in the mixing, thereby reducing the amount of unmixed material.

In order to complex the electrode active material and the conductive material, mixing needs to be performed under appropriate conditions. In an illustrated embodiment, the electrode active material 2 may be a cathode active material or an anode active material.

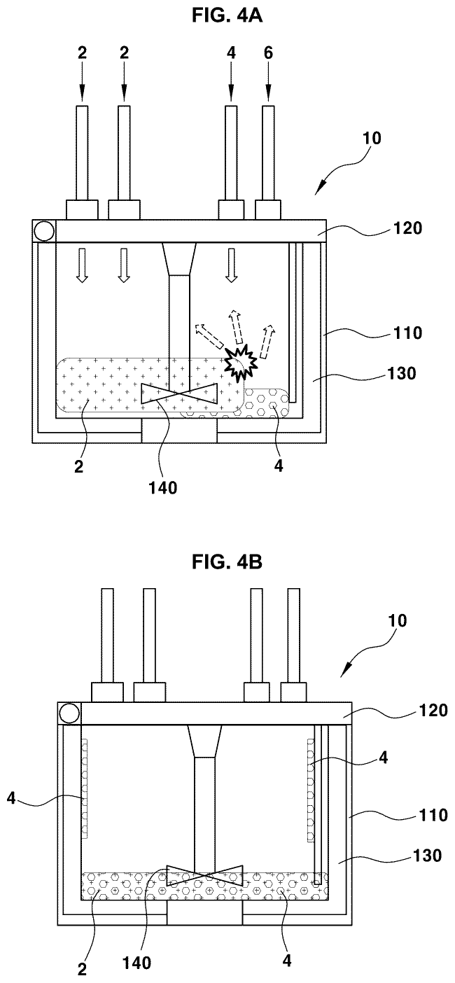

In one example, as illustrated in FIG. 3A, the conductive material 4 is supplied into the mixer 10 after the electrode active material 2 is supplied. When the mixer 10 is driven in this state, a proper level of complexing is not achieved. Generally, the specific gravity of the conductive material 4 is very small. Therefore, the conductive material 4 floats inside the mixer 10 during the mixing process, and as illustrated in FIG. 3B, some of the conductive material 4 are coated on the upper surface of the chamber 130.

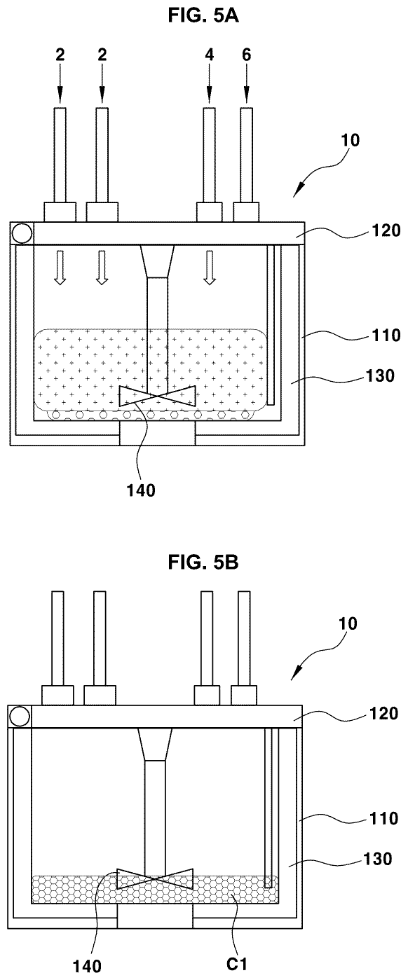

In another example, as illustrated in FIG. 4A, the electrode active material 2 is supplied into the mixer 10 after the conductive material 4 is supplied. In this case, the electrode active material 2, which has a large specific gravity, falls and lifts most of the conductive material 4, which has a small specific gravity. Eventually, the layer of the electrode active material 2 is separated from the layer of the conductive material 4, and when the mixer 10 is driven, similar to the case of FIG. 3B, the conductive material 4 is coated on the inner surface of the chamber 130, not on the electrode active material 2 (see FIG. 4B).

To solve the problem, according to an embodiment of the present disclosure, a buffer layer is formed between the electrode active material 2 and the conductive material 4. Through experiments, the inventors of the present disclosure were able to confirm that the formation of the buffer layer allows the electrode active material 2 and the conductive material 4 to be properly complexed.

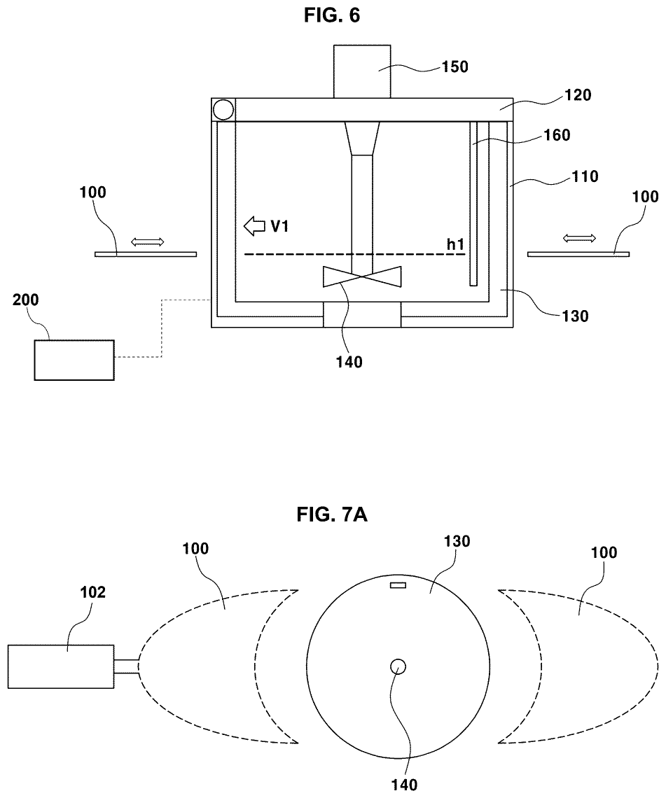

Specifically, as illustrated in FIG. 5A, in an experiment, the conductive material 4 was placed at the very bottom within the chamber 130. Then the electrode active material 2 was placed above the conductive material 4 at a distance close enough for the electrode active material 2 to almost touch the conductive material 4 so that the electrode active material 2 does not fall with a potential energy. In this state, a mixing process was carried out by the mixer 10, and it was confirmed that the electrode active material 2 and the conductive material 4 were well complexed (C1), as illustrated in FIG. 5B.

In some embodiments, the buffer layer may be formed by, as described with reference to FIGS. 5A and 5B, distributing the electrode active material 2 above the conductive material 4 distributed within the chamber 130 at a position close to the conductive material 4. In other words, the buffer layer may be formed by distributing the electrode active material 2 above the conductive material 4 at a position that the potential energy of the electrode active material 2 with respect to the conductive material 4 is very small or substantially does not exist. Differently put, according to the present disclosure, inside the chamber 130, the electrode active material 2 is distributed at a height having a potential energy within a predetermined range with respect to the conductive material 4. In this specification, “the potential energy substantially does not exist” means that the potential energy of the electrode active material 2 with respect to the conductive material 4 is 0, or is not 0 but has a very small value close to 0. However, in mass production of a dry electrode, it is difficult to slowly distribute the electrode active material 2 supplied through the vacuum conveyor 16 onto the conductive material 4. For this reason, according to the present disclosure, in a case such as vacuum conveying where it is difficult to distribute the electrode active material 2 by removing the potential energy thereof, the electrode active material 2 may be distributed onto the conductive material 4 by removing the potential energy using the separator 100, which may serve as the buffer layer, so that the electrode active material 2 does not fall directly onto the conductive material 4 due to gravity.

According to the present disclosure, the buffer layer may enable complexing of the conductive material and the electrode active material and fiberizing of the binder, using a single mixer 10. Specifically, the bulk density of the conductive material is very small (approximately 0.5 gram/centimeter³ or less). Due to such characteristics of the conductive material, coating of the conductive material on the electrode active material is very difficult, as observed in FIGS. 3A, 3B, 4A, and 4B. In a conventional mixer, the space where the blade could apply energy was limited and the space where the conductive material could move was large, so the mixer having a smaller space was used for coating. In other words, the conductive material and the electrode active material were complexed in a small first mixer, and then the complexed conductive material and electrode active material and the binder were mixed in a large second mixer. However, according to the present disclosure, a separator is used without having to use any additional additives by taking advantage of the fact that the electrode active material is heavier than the conductive material. Because the separator allows the conductive material and the electrode active material to be mixed while the conductive material is confined by the electrode active material, an additional mixer for coating the conductive material is not needed.

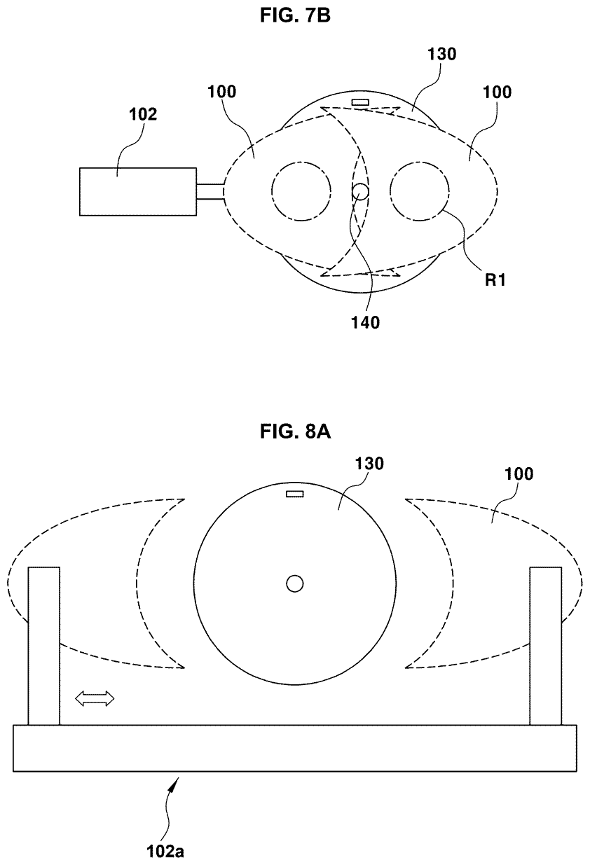

According to an embodiment of the present disclosure, the buffer layer may be formed by the separator 100. As illustrated in FIG. 6, after the conductive material 4 is dispensed into the chamber 130, the separator 100 is introduced into the chamber 130 to serve as a buffer layer. For example, the vertical position of the conductive material 4 accumulated in the chamber 130 is h1, and the separator 100 is introduced into the chamber 130 after the conductive material 4 is distributed into the chamber 130.

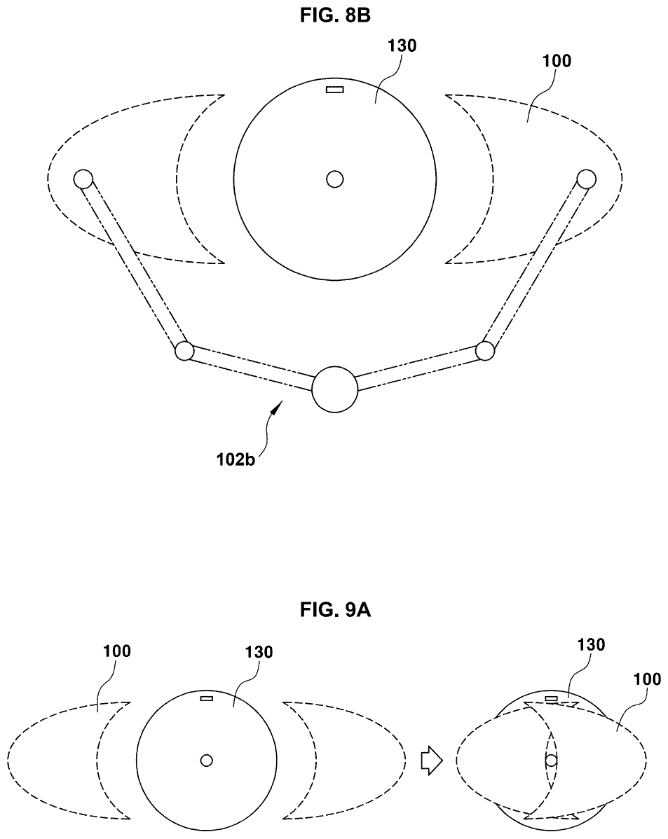

The separator 100 may be introduced into the chamber 130. Moreover, the separator 100 may be pulled out of the chamber 130. To this end, in an embodiment as illustrated in FIG. 7A, the separator 100 may be introduced into or pulled out of the chamber 130 by an actuator. As a non-limiting example, the actuator may be an electric cylinder 102, but not limited thereto.

In an embodiment, two separators 100 may be arranged to face each other. The two separators 100 facing each other may be introduced into the chamber 130 by moving toward each other and may be pulled out of the chamber 130 by moving away from each other.

In an embodiment, the two separators 100 may have different vertical positions. In other words, as illustrated in FIG. 7B, the two separators 100 may partially overlap each other. Because the vertical positions of the two separators 100 are different from each other, the two separators 100 may not interfere with each other. Moreover, the separators 100 may be arranged not to interfere with other components within the mixer 10.

After the conductive material 4 is piled inside the chamber 130, the two separators 100 may move toward each other. When the two separators 100 partially overlap each other, the electrode active material 2 may be supplied to a drop region R1. When the electrode active material 2 is supplied to the drop region R1, the potential energy of the electrode active material 2 generated at the vertical position of the vacuum conveyor 16 may be removed by the separator 100. Then when the electric cylinder 102 is operated and the separator 100 is pulled out of the chamber 130 the electrode active material 2 may confine the conductive material 4 from above.

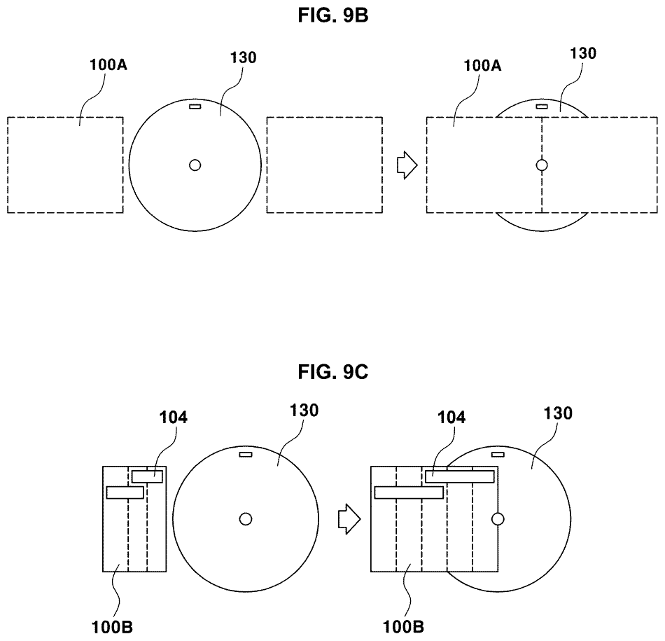

As illustrated in FIGS. 8A and 8B, the actuator to move the separator 100 may have a different structure. In some embodiments, as illustrated in FIG. 8A, the separator 100 may be connected to a powered rail 102a. The separator 100 may move into or out of the chamber 130 by being driven by the powered rail 102a. As illustrated in FIG. 8B, in some embodiments, the separator 100 may be connected to a multi-joint arm 102b. The multi-joint arm 102b may be driven by a motor, etc. By the movement of the multi-joint arm 102b, the separator 100 may be moved into or out of the chamber 130.

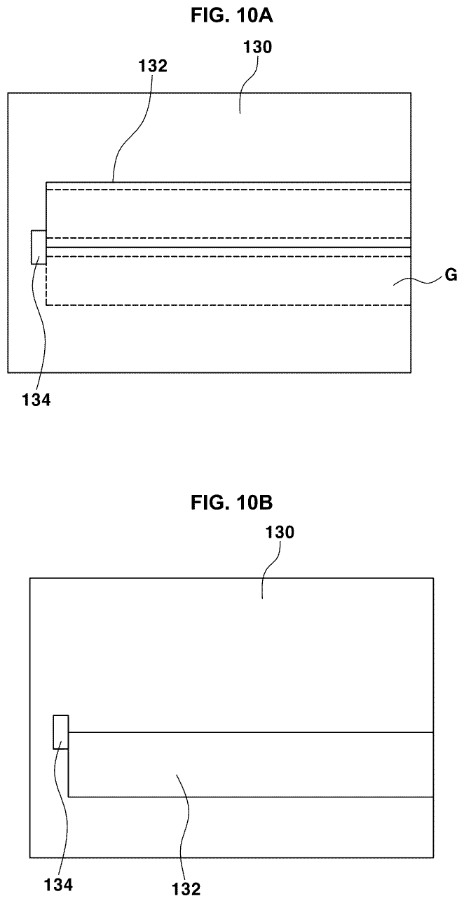

As illustrated in FIGS. 9A, 9B, and 9C, the separator may have various shapes. As illustrated in FIG. 9A, in one embodiment, two separated separators 100 may overlap each other. As illustrated in FIG. 9B, in one embodiment, two separators 100a may be brought into contact with each other. As illustrated in FIG. 9C, in one embodiment, the separator 100b may be foldable. In the embodiment, the separator 100b may include a cylinder 104. The separator 100b may stay in multiply folded state, such as being folded in two or three layers, and then be unfolded by the driving of the cylinder 104, within the chamber 130.

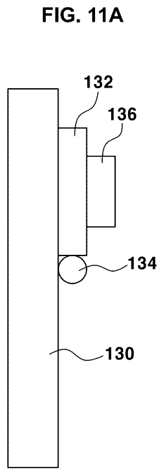

Referring to FIGS. 10A and 10B, the mixer 10 includes an opening G. Through the opening G, the separator 100 may be introduced into or pulled out of the chamber 130. The opening G may be open when the separator 100 is introduced into the chamber 130, and the opening G may be closed after the separator 100 forms a buffer layer between the conductive material 4 and electrode active material 2 and then is pulled out of the chamber 130.

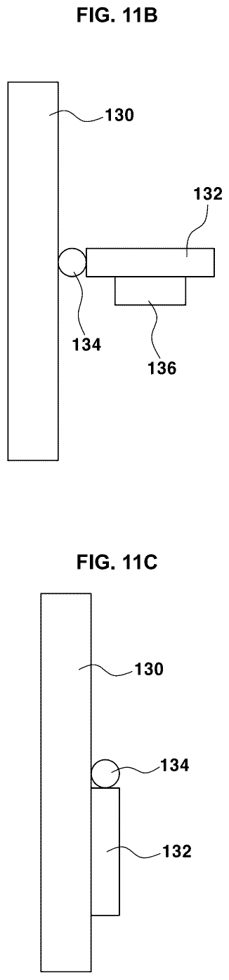

Referring to FIGS. 11A, 11B, and 11C, in an embodiment, the chamber 130 may be provided with a door 132. The door 132 may be connected to a rotation shaft 134 provided within the chamber 130 and may be rotated by the rotation of the rotation shaft 134. The door 132 starts rotating in a state in which the opening G is open as in FIG. 11A, passes through the state in FIG. 11B, and then an insertion portion 136 of the door 132 is inserted into the opening G to close the gap G. In an embodiment, when the chamber 130 has a shape with only a curved surface, such as a cylindrical shape or an oval cylinder shape, a plurality of doors 132 that is segmented from each other may be provided. Moreover, the door 132 may have a curvature to correspond to the shape of the chamber 130.

The controller 200 may control the operation of the apparatus for manufacturing a dry electrode. For example, the controller 200 may control the operation of the measuring system 12 and the vacuum conveyor 16 to determine when to supply the material to the mixer 10, what material to supply, etc. Moreover, the controller 200 may control the operation of the mixer 10. The controller 200 may control the rotation of the blade 140 and chamber 130 of the mixer 10. The controller 200 may control the operation of the separator 100. The controller 200 may control the operation of the separator 100 by driving the actuator for the separator 100, e.g., the electric cylinder 102. The controller 200 may introduce the separator 100 into the mixer 10 at a preset time point and may pull the separator 100 out of the mixer 10 at a preset time point. Moreover, the controller 200 may control the opening or closing of the door 132.

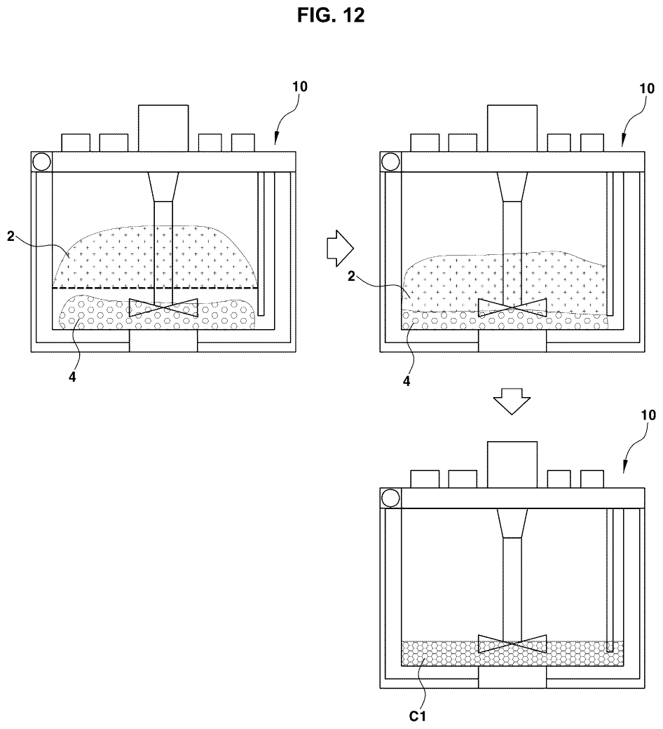

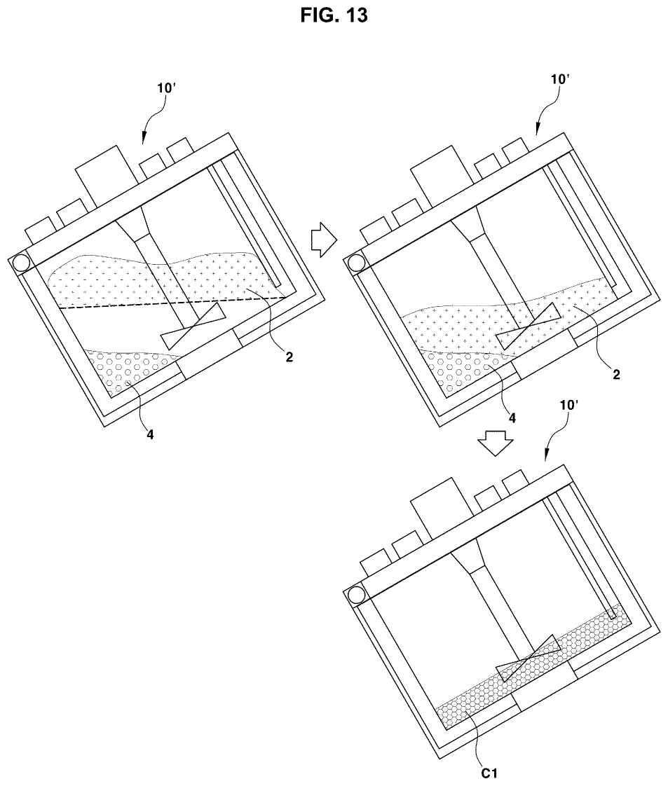

Referring to FIGS. 12 and 13, according to the present disclosure, the buffer layer may be applied not only in the mixer not being tilt (the example in FIG. 12), but also in a mixer 10′ being tilt.

According to the present disclosure, when a buffer layer is formed during mixing of the conductive material 4 and the electrode active material 2, the conductive material 4 and the electrode active material 2 may be properly complexed.

Specifically, when the electrode active material 2 and conductive material 4 are well complexed, the conductive material 4 having a high electrical conductivity is well coated on the surface of the electrode active material 2. For this reason, well complexed electrode active material 2 and conductive material 4 has a higher electrical conductivity than poorly complexed electrode active material 2 and conductive material 4, which was confirmed through experiments.

As shown in Table 1, five samples were prepared, and the electrical conductivity of each sample was measured. The electrical conductivity shown in the table is the average electrical conductivity and is the average value of twenty electrical conductivities measured by putting 4 grams of each sample into a pellet having a diameter of 2 centimeters and applying a force every 1 kilonewton (kN) in the range of 1 to 20 kN.

TABLE 1

| | | Electrical conductivity |
|---|---|---|
| Sample No. | Material | (Siemens/centimeter) |
| 1 | Electrode active material | 0.01396 |
| (Comparative | | |
| Embodiment | | |
| 1) | | |
| 2 | Electrode active material + Conductive | 0.01510 |
| (Comparative | material 1 | |
| Embodiment | | |
| 2) | | |
| 3 | Electrode active material + Conductive | 0.01695 |
| (Comparative | material 2 | |
| Embodiment | | |
| 3) | | |
| 4 | Sample 1 having a buffer layer | 0.05722 |
| (Embodiment | (Sample in which conductive material is | |
| 1) | supplied first and active material is added | |
| | onto the conductive material layer to | |
| | confine the conductive material) | |
| 5 | Sample 2 having a buffer layer | 0.05706 |
| (Embodiment | (Sample in which conductive material is | |
| 2) | supplied first and active material is added | |
| | onto the conductive material layer to | |
| | confine the conductive material) | |

When the electrode active material and the conductive material are simply supplied into the chamber 130 and mixed, the conductive material 4, which has a small specific gravity, is lifted and not properly coated on the electrode active material 2. As a result, there is no significant difference in the electrical conductivity values between Comparative Embodiments 2 and 3, wherein the electrode active material and the conductive material are mixed, and Comparative Embodiment 1, wherein only the electrode active material is included.

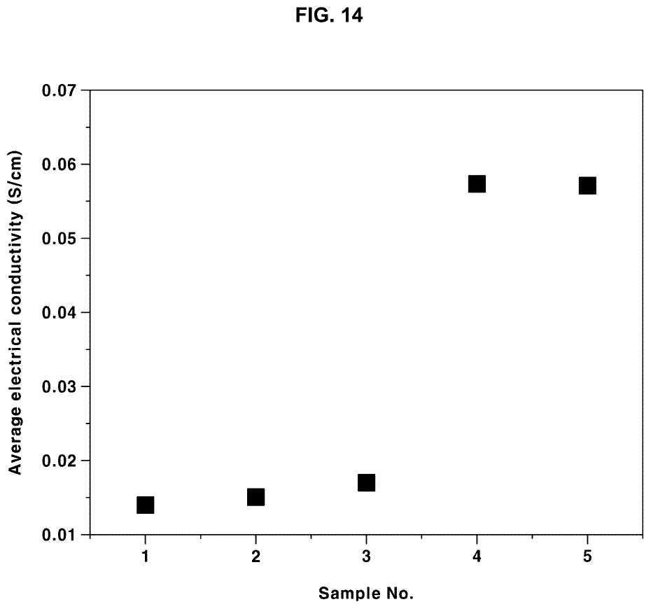

However, Embodiments 1 and 2, wherein the buffer layer according to the present disclosure is used, confirm to have the electrical conductivity approximately 3 to 4 times greater than the electrical conductivity in Comparative Embodiments 1 to 3. This may also be confirmed in the graph in FIG. 14.

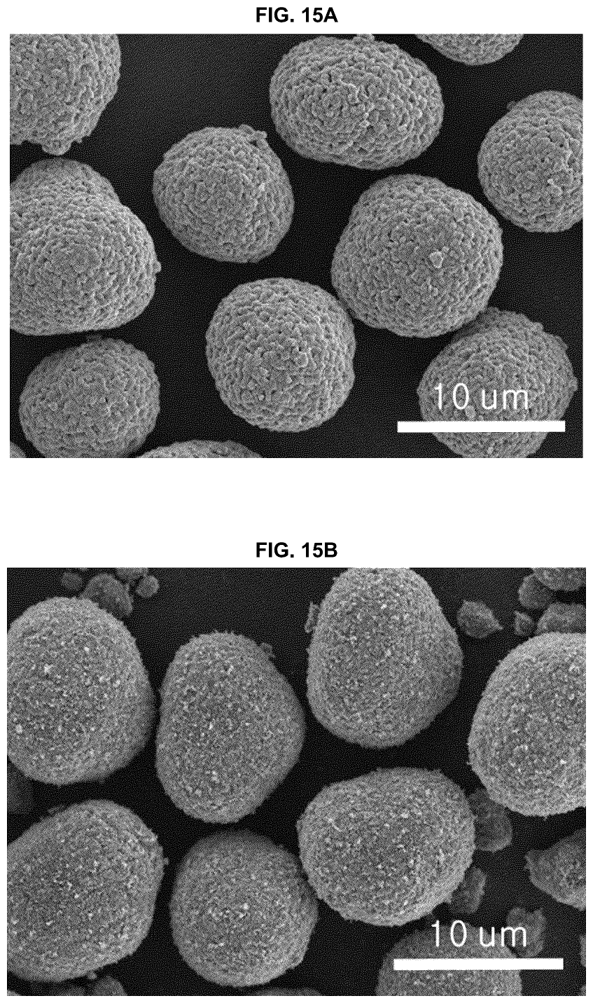

Moreover, when the electrode active material and the conductive material are simply added and mixed, it is difficult to confirm, as shown in FIG. 15A, whether the conductive material is coated. However, in Embodiments 1 and 2 as in FIG. 15B, it was confirmed through an electron microscope image showing that the conductive material 4 was well coated on the surface of the electrode active material 2.

According to the present disclosure, provided are an apparatus and method for manufacturing a dry electrode, capable of excellently complexing electrode active material with conductive material during the manufacture of the dry electrode.

According to the present disclosure, complexation of electrode active material and conductive material and fiberization of binder are possible in one mixer without the need to use an additional mixer, thereby reducing investment costs and increasing layout efficiency.

As is apparent from the above description, the present disclosure provides the following effects.

According to the present disclosure, provided are an apparatus and method for manufacturing a dry electrode, capable of effectively complexing electrode active material and conductive material.

According to the present disclosure, provided are an apparatus and method for manufacturing a high-quality dry electrode.

Effects of the present disclosure are not limited to what has been described above, and other effects not mentioned herein will be clearly recognized by those skilled in the art based on the above description.

It will be apparent to those of ordinary skill in the art to which the present disclosure pertains that the present disclosure described above is not limited by the above-described embodiments and the accompanying drawings, and various substitutions, modifications and changes are possible within a range that does not depart from the technical idea of the present disclosure.

What is claimed is:

1. A method for manufacturing a dry electrode, the method comprising:
supplying a conductive material into a mixer;
distributing an electrode active material on the conductive material within the mixer; and
driving the mixer.

2. The method of claim 1, wherein, within the mixer, the electrode active material is distributed onto the conductive material at a height having substantially no potential energy with respect to the conductive material.

3. The method of claim 1, further comprising forming a buffer layer on the conductive material, wherein the buffer layer is formed by positioning the electrode active material close to the conductive material to prevent floating, before distributing the electrode active material.

4. The method of claim 3, further comprising:
supplying the electrode active material on the buffer layer; and
removing the buffer layer after the electrode active material has been placed, allowing the active material to fall onto the conductive material.

5. The method of claim 1, further comprising supplying a binder into the mixer, after the driving the mixer.

6. The method of claim 5, further comprising:
directing a mixture of the electrode active material, the conductive material, and the binder within the mixer to a roll press; and
forming the mixture into a film through the roll press.

7. A dry electrode manufactured by the method according to claim 1.

8. A secondary battery comprising the dry electrode according to claim 7.

9. An apparatus for manufacturing a dry electrode, the apparatus comprising:
a vacuum conveyor configured to deliver a material comprising an electrode active material, a conductive material, and a binder;
a mixer supplied with the material delivered by the vacuum conveyor and configured to mix the material; and
a separator capable of being introduced into the mixer.

10. The apparatus of claim 9, wherein the mixer comprises:
a chamber defined within the mixer and being rotatable; and
a blade rotatable within the mixer.

11. The apparatus of claim 9, further comprising an actuator configured to move the separator into or out of the mixer.

12. The apparatus of claim 9, wherein the mixer further comprises an opening through which the separator passes.

13. The apparatus of claim 12, wherein the mixer further comprises a door capable of closing the opening, wherein the door can open and close in sync with the insertion or removal of the separator.

14. The apparatus of claim 9, wherein the separator comprises an area where the electrode active material is arranged within the mixer.

15. The apparatus of claim 9, further comprising a controller configured to control an operation of the vacuum conveyor, the mixer, and the separator.

16. The apparatus of claim 15, wherein the controller is configured to:
supply the conductive material into the mixer by driving the vacuum conveyor,
introduce the separator into the mixer,
distribute the electrode active material onto the separator by driving the vacuum conveyor,
pull the separator out of the mixer, and
operate the mixer after the separator is pulled out of the mixer.

17. The apparatus of claim 16, wherein the controller is further configured to:
after operating the mixer, supply the binder into the mixer by driving the vacuum conveyor; and
drive the mixer.

18. A dry electrode manufactured by the apparatus according to claim 9.

19. A secondary battery comprising the dry electrode according to claim 18.

20. A method for manufacturing a dry electrode, the method comprising:
supplying a conductive material into a mixer,
forming a buffer layer between an electrode active material and the conductive material;
distributing the electrode active material onto the conductive material within the mixer by removing the buffer layer;
driving the mixer to mix the conductive material and the electrode active material;
introducing a binder into the mixer after the electrode active material and conductive material have been complexed; and
driving the mixer to fiberize the binder, thereby forming a dry electrode mixture.
